(19) United States
(12) Patent Application Publication
(10) Pub. No.: US 2010/0300849 A1
(43) Pub. Date: Dec. 2, 2010

(54) BELT WITH EDGE REINFORCEMENT

(76) Inventors: Michael Spence, Blackburn Lancashire (GB); Paul Raymond Riding, Blackburn Lancashire (GB); John Jeffery, Blackburn Lancashire (GB); Andrew Allum, Darwen Lancashire (GB)

Correspondence Address: TAYLOR IP, P.C., P.O. Box 560, 142. S Main Street, Avilla, IN, 46710, US

(21) Appl. No.: 12/723,811

(22) Filed: Mar. 15, 2010

Related U.S. Application Data
(63) Continuation of application No. PCT/EP2008/055221, filed on Apr. 29, 2008.

(30) Foreign Application Priority Data
Sep. 15, 2007 (DE) 10 2007 044 552.2

(51) Int. Cl. B65G 15/34; B05D 1/36

(52) U.S. Cl. 198/846; 427/261

(57) ABSTRACT

The present invention relates to a belt to transport a material web in a web producing and/or web converting machine, especially a paper, cardboard or tissue machine from a first transfer location to a second transfer location, whereby the belt is bordered in a cross direction on each side by a respective longitudinal edge, whereby the belt includes a weight-carrying base structure which is disposed between a paper side polymer layer and a machine side polymer layer and in the region of at least one longitudinal edge an edge reinforcement is provided. The present invention is characterized in that the edge reinforcement is formed in that the two polymer layers protrude in the region of the longitudinal edge in the cross direction beyond the base structure and a hereby created groove extending in the longitudinal direction of the belt is filled at least in sections with a polymer material. The present invention also relates to a method for the manufacture of a belt.

### CROSS REFERENCE TO RELATED APPLICATIONS

This is a continuation of PCT application No. PCT/EP2008/055221, entitled “TRANSPORTING BELT WITH PERIPHERAL REINFORCEMENT”, filed Apr. 29, 2008, which is incorporated herein by reference.

### BACKGROUND OF THE INVENTION

1. Field of the Invention

The present invention relates to a belt, especially a belt or process belt for web converting and/or web producing machines, especially paper, cardboard or tissue machines.

2. Description of the Related Art

Belts are utilized in paper machines, for example, to transport a paper web in the paper machine from a first transfer location where the material web is transferred from one clothing onto the belt to a second transfer location where the material web is transferred from the belt to an additional clothing. On such belts the paper web is frequently run through a press nip between the two transfer locations. In this case, a smoothing of the web, for example caused by the belt, would occur. The belts in question normally have a weight-carrying structure, for example in the form of a woven structure, on which a polymer layer representing the paper side and which is often impermeable is disposed. A disadvantage of belts known from the current state of the art is that the belt edges extending in a longitudinal direction of the belt often become “frayed” or abraded, resulting in a weakening of the belt edges.

What is needed in the art is an improved belt which provides greater wear resistance at the belt edges.

### SUMMARY OF THE INVENTION

If the belt has only one paper side polymer layer, the present invention provides a belt which transports a material web in a web producing and/or web converting machine, especially a paper, cardboard or tissue machine, which is bordered in a cross direction on each side by a respective longitudinal edge. The belt includes a weight-carrying base structure and a polymer layer disposed on the base structure providing the paper side of the belt. In the region of at least one longitudinal edge, an edge reinforcement providing at least a section of the longitudinal edge is formed. The paper side polymer layer protrudes in the area of the longitudinal edge in the cross direction beyond the base structure and a hereby created step extending in the longitudinal direction of the belt is filled at least in sections with a polymer material as a result of which the edge reinforcement forms at last part of the longitudinal edge.

If the belt has a paper side and a machine side polymer layer, the present invention provides a belt which transports the material web in a web producing and/or web converting machine, especially a paper, cardboard or tissue machine and which is bordered in cross direction on both sides by a respective longitudinal edge. The belt includes a weight-carrying base structure which is disposed between a paper side polymer layer and a machine side polymer layer. In the region of at least one longitudinal edge, an edge reinforcement providing at least a section of the longitudinal edge is formed, whereby the two polymer layers protrude in the region of the longitudinal edge in cross direction beyond the base structure, forming a groove extending in longitudinal direction of the belt, which is filled at least in sections with a polymer material.

In other words, the edge reinforcement includes a polymer material and, viewed in cross direction of the belt, the paper side polymer layer (and the machine side polymer layer) protrudes toward the longitudinal edge of the belt beyond one end of the base structure, whereby at least one part of the longitudinal edge of the belt is formed in that the polymer material at least partially covers the section of the polymer layer protruding beyond the edge of the base structure and in that the polymer material completely covers the end of the base structure.

The present invention is based on the concept of protecting the base structure which is often susceptible to wear in the area of the belt edge with a polymer material. According to the present invention, in the region of the belt edge, the paper side polymer layer protrudes toward the outside beyond the end of the base structure and the space which is created by the section of the polymer layer protruding over the end of the base structure and the end of the base structure is filled at least in sections with a polymer material.

The polymer material forming the edge reinforcement is, for example, in the embodiment of one piece. One embodiment of the present invention, for example, provides that the polymer material filling the step or groove respectively is formed complementary to the form of the step or groove respectively. This may be achieved, for example, in that the polymer material is filled into the step or groove respectively in a formless form, for example in a liquid form, and is subsequently solidified. The polymer material may, for example, be solidified or hardened through heat effect. In addition, it is conceivable that the polymer material cross-links with itself and/or with the polymer material of the paper side and/or the machine side polymer layer. Due to the fact that the polymer material is added in a formless state, it is able to completely fill all hollow spaces in the step or groove respectively. After its solidification, the polymer material of the edge reinforcement assumes a complementary form in the contact area with the polymer layer(s) and the base structure with these and is, therefore, firmly joined with them. It is, therefore, conceivable that the edge reinforcement is linked through a material fit and/or friction and/or form fit with the at least one polymer layer and with the base structure. Connections where all connecting partners are held together by atomic or molecular forces are termed a material fit connection. For example, this is to be understood to be connection through gluing, chemical cross-linking or vulcanizing. A friction connection in this context is to be understood to be a connection which is established by the use of force whereby the cohesiveness of the bonding partners is assured through static friction.

As a rule the polymer material of the edge reinforcement fills the groove or respectively the step at least partially from the end of the base structure. Viewed as a cross section of the belt, the groove can, for example, be configured so that the distance between the surfaces of the paper side and the machine side polymer layer facing each other remains constant from the inside of the belt, that is from the end of the base structure toward the longitudinal edge of the belt. In this case the groove is, for example, U-shaped. Alternatively, it is conceivable that the groove is designed so that the distance between the surfaces of the paper side and the machine side polymer layer facing each other increases or decreases from the inside of the belt toward the longitudinal edge of the belt. In this case, the groove can be designed to be V-shaped. If the groove enlarges toward the longitudinal edge, then the wear volume provided by the polymer material of the edge reinforcement increases in the cross direction, from the end of the base structure toward the end of the paper side and/or machine side polymer layer. The belt may, for example, have a constant thickness across its entire width. This means that on the paper side and the machine side of the belt the area around the belt edge is no thicker compared to the belt center.

In order to further improve the wear resistance of the belt, a second embodiment of the present invention provides that the polymer material of the edge reinforcement, viewed in the cross direction of the belt, protrudes at least in sections beyond the paper side polymer layer and/or beyond the machine side polymer layer. This results in the fact that the longitudinal edge of the belt, according to the present invention has a section protruding in the cross direction of the belt beyond the paper side and machine side (if this is provided) polymer layer which is formed by the edge reinforcement and which represents a wear volume of the longitudinal edge of the belt edge.

The polymer material of the edge reinforcement may be a different polymer material than the polymer material of the paper side polymer layer and/or the polymer material of the machine side polymer layer. In this context, the polymer material of the edge reinforcement may have a greater hardness and/or a greater abrasion resistance than the polymer material of the paper side polymer layer and/or the polymer material of the machine side polymer layer. This allows for a further improvement in the wear resistance of the belt edge. It is conceivable, in this context that the polymer material of the paper side and/or the machine side polymer layer has a hardness in the range of between approximately 20 and 95 Shore A, whereas the polymer material of the edge reinforcement has a greater hardness than the paper side and/or the machine side polymer layer, which can be in the range of between approximately 50 Shore A to 90 Shore D, for example between approximately 50 Shore A to 95 Shore A. It is conceivable in this context that the two polymer layers as well as the polymer material of the edge reinforcement are formed of polyurethane, whereby the polyurethane of the edge reinforcement is harder than the polyurethane of the two polymer layers. The polymer material of the one or of both polymer layers may, for example, include polyurethane. The polymer material of the edge reinforcement can include, for example, polyurethane, silicone, polyamide, epoxy resins, polyolefin, polyester or amide, alone or in combination.

A third embodiment of the present invention provides that the polymer material of the edge reinforcement is thixotropic and, for example, has a viscosity in the range of between approximately 400000 cps to 1000000 cps.

In order to further increase the abrasion resistance of the edge reinforcement, a fourth embodiment of the present invention provides that a filler, for example, a particulate filler, i.e. SiC (silicone carbide) and/or CaCO³ (calcium carbonate) which has a higher abrasion resistance than the polymer material of the edge reinforcement is embedded into the polymer material of the edge reinforcement.

The polymer material of the edge reinforcement extends, for example, in the cross machine direction from the longitudinal edge in an area of between approximately 1 mm to 15 mm, for example between approximately 2 mm to 7 mm, toward the inside. If the base structure includes, for example, longitudinal yarns which extend parallel to the longitudinal edge, then the step or groove can be formed, for example, by removing the longitudinal yarn or yarns which are located at the outermost region of the longitudinal edge—viewed in the cross direction of the belt—from the base structure.

Different possibilities are conceivable with regard to the design of the weight carrying base structure. It is conceivable that the weight carrying base structure is formed by a textile surface structure, for example, by a woven structure, a group of yarns extending in a machine direction and/or a cross machine direction and/or by a non-textile surface structure, for example, by one or more film(s). The belt according to the present invention may be a belt whereby the paper side and/or machine side polymer layer is fluid impermeable.

An additional aspect of the present invention provides a method for the manufacture of a belt to transport a material web in a web converting and/or web producing machine including:

a) provision of a weight-carrying base structure;

b) coating of one side of the base structure with a first polymer material to provide a paper side of the belt;

c) removal of part of the base structure in at least one edge area of the semi-completed belt in a way that the paper side polymer layer viewed in cross direction of the belt protrudes beyond the base structure;

d) at least sectional filling of the space which is created between the paper side polymer layer and the base structure with a formless second polymer material in order to form at least one section of the longitudinal edge of the belt; and

e) solidifying of the formless second polymer material.

One embodiment of the method according to the present invention provides that in step b) the one side of the base structure is coated with the first polymer material to provide the paper side and simultaneously or subsequently the other side of the base structure, opposite the one side is coated with a third polymer material. It is conceivable in this context that the first and the third polymer material are the same polymer material.

A second embodiment of the method according to the present invention provides that in step c) a part of the base structure in an edge area of the semi-completed belt is removed in a way that the paper side and the machine side polymer layer viewed in the cross direction of the belt protrude beyond the base structure. If the belt includes a paper side and a machine side polymer layer, then step d) provides that the groove (this extends in a longitudinal direction of the belt) formed between the paper side polymer layer, the machine side polymer layer and the base structure is filled at least in sections with the second polymer material in order to form at least one section of the longitudinal edge of the belt. The second formless polymer material, for example liquid polymer material, is filled into the space, for example by a casting process.

A third embodiment of the method according to the present invention further provides that the base structure includes longitudinal yarns extending in a longitudinal direction of the belt and that in step c) the two outermost longitudinal yarns are removed from the base structure in the at least one edge region.

In order to clearly increase the durability of the belt produced with the method according to the present invention in step e) a solid bond is formed between the second polymer material and the base structure and the paper side and/or machine side polymer layer.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a first embodiment of a belt according to the present invention;

FIG. 2 illustrates a second embodiment of a belt according to the present invention;

FIG. 3 illustrates different design forms of a longitudinal edge on a belt according to the present invention; and

FIG. 4 illustrates an embodiment of the method according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

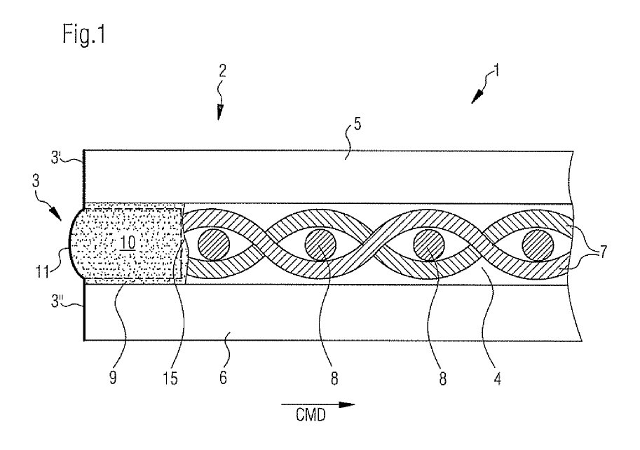

Referring now to the drawings, and more particularly to FIG. 1, there is shown belt tin the region of one of its two belt edges 2, viewed in a cross machine direction (CMD). Belt 1 is bordered in the cross machine direction (CMD) on both sides by longitudinal edge 3, only one of which is shown here. Belt 1 includes weight-carrying base structure 4 in the embodiment of woven structure 4, which is disposed between impermeable paper side polymer layer 5 and impermeable machine side polymer layer 6. Woven structure 4, which represents base structure 4, includes cross yarns 7 which are interwoven with longitudinal yarns 8 extending parallel to longitudinal edge 3. In addition, belt 1 includes edge reinforcement 11 in region 2 of longitudinal edges 3. Edge reinforcement 11 is created according to the present invention whereby in region 2 of longitudinal edge 3, two polymer layers 5, 6 extend in the cross machine direction (CMD) of belt 1 beyond base structure 4 and thereby formed groove 9 (indicated by a broken line) which extends in a longitudinal direction of belt 1 is completely filled with polymer material 10. Viewed in the cross machine direction of the belt 1, polymer material 10 which forms edge reinforcement 11 thereby connects with end 15 of base structure 4 which faces toward longitudinal edge 3 of belt 1, thereby covering it.

It is to be noted that that the longitudinal direction of belt 1 in the illustration in FIG. 1 extends vertically to the drawing plane. In addition it is to be noted that longitudinal edge 3 of belt 1 is formed by two end edges 3′ and 3″ of two polymer layers 5,6 and the outward curved end edge of polymer material 10 (the progression of longitudinal edge 3 is shown as a cross section by a bold line).

Polymer material 10 which fills groove 9 is complementary in form to groove 9. This is achieved predominantly in that polymer material 10 is filled into groove 9 in a liquid state and is subsequently solidified through heat effect. During solidification polymer material 10 is interlinked with itself, as well as with the polymer material of aper side polymer layer 5 and machine side polymer layer 6. Belt 1 has a constant thickness across its entire width. It is further to be recognized that polymer material 10 of edge reinforcement 11, viewed in the cross machine direction CMD of belt 1, extends beyond paper side polymer layer 5 and beyond machine side polymer layer 6, thereby providing an increased wear volume.

The polymer material in two polymer layers 5, 6 in the current example is polyurethane (PU) with a hardness of approximately 85 Shore A, whereas polymer material 10 of edge reinforcement 11 is PU with a hardness of approximately 60 Shore D. In addition, a particulate filler, for example SiC (silicone carbide), is embedded into polymer material 10 of edge reinforcement 11. SiC has a greater abrasion resistance than the PU of edge reinforcement 11.

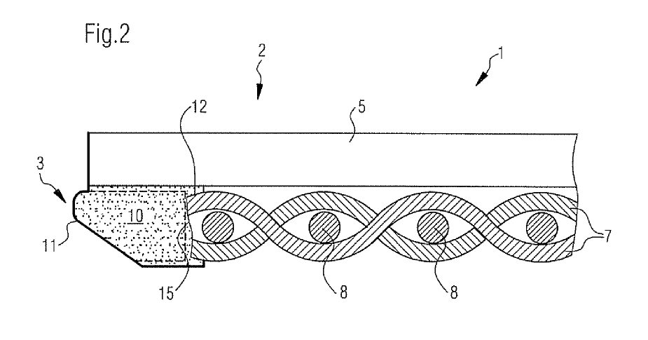

Referring now to FIG. 2, there is shown belt 1 in the region of one of two belt edges 2, shown in the cross machine direction (CMC). Below, only differences to the belt illustrated in FIG. 1 are addressed. Belt 1 has a weight-carrying base structure in the form of woven structure 4 and polymer layer 5 providing the paper side of belt 1 disposed on base structure 4. On belt 1, illustrated in FIG. 2, edge reinforcement 11 is formed in that in the region of longitudinal edge 3 (the progression of longitudinal edge 3 viewed cross sectionally is indicated by a bold line) paper side polymer layer 5 protrudes in the cross direction of belt 1 beyond base structure 4 and a hereby created step 12 (indicated by broken line) extending in the longitudinal direction of belt 1 is filled at least in sections with polymer material 10. Viewed in the cross machine direction of the belt, polymer material 10, which forms edge reinforcement 11, thereby connects with end 15 of base structure 4 which faces toward longitudinal edge 3 of belt 1, thereby covering it. It is to be noted that that the longitudinal direction of belt 1 in the illustration in FIG. 1 extends vertically to the drawing plane.

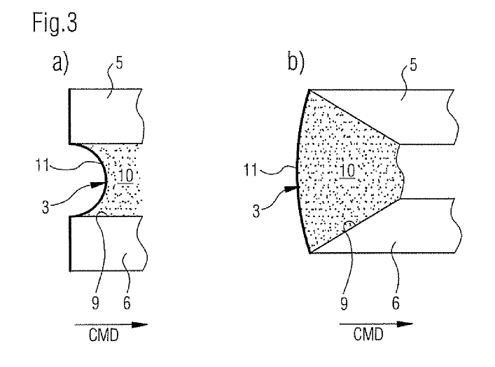

Referring now to FIG. 3, there is shown various design possibilities for a longitudinal edge of the belt according to the present invention. In the variation shown in FIG. 3a, groove 9 is designed so that—viewed in a cross section of the belt—the distance between paper side 5 and machine side polymer layer 6 remains constant from inside toward the longitudinal edge of the belt. In addition, groove 9 in the variation illustrated in FIG. 3 is only partially filled. In other words, polymer material 10 of edge reinforcement 11, viewed in the cross machine direction CMD of belt 1 does not protrude beyond paper side polymer layer 5 and not over machine polymer layer 6. In the variation shown in FIG. 3b, the groove is designed so that the distance between paper side polymer layer 5 and machine side polymer layer 6 increases from inside of belt 1 toward longitudinal edge 3 of belt 1. In this case, longitudinal edge 3 of belt 1 is essentially formed completely by edge reinforcement 11.

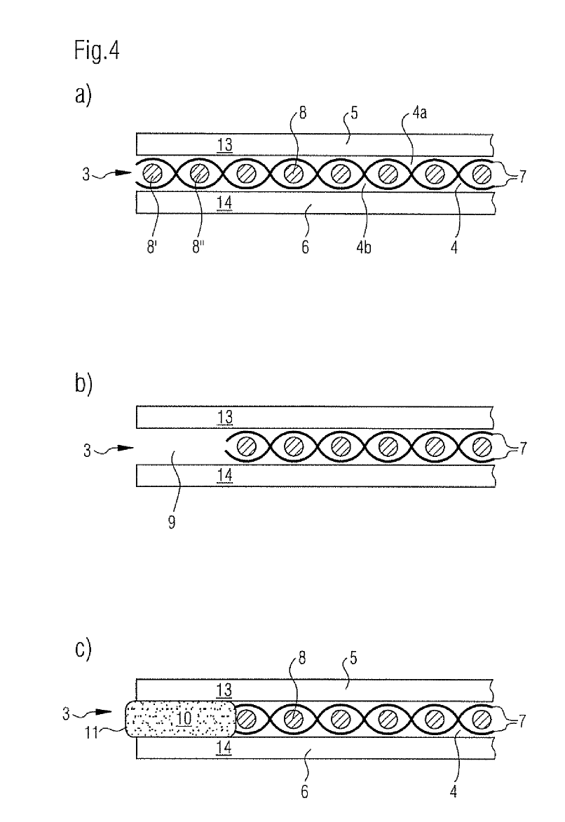

Referring now to FIG. 4, there is shown one design form of the method according to the present invention to manufacture the belt illustrated in FIG. 1. FIG. 4a shows belt 1 which was produced whereby weight-carrying base structure 4 was coated on side 4a with first polymer material 13 to provide a paper side of belt land simultaneously side 4b of base structure 4, opposite side 4a was coated with third polymer material 14. FIG. 4b illustrates the production state of the belt whereby one section of base structure 4a was removed in one region of longitudinal edge 3 of the semi-completed belt. Specifically, outermost longitudinal yarns 8′ and 8″ of the base structure in the embodiment of woven structure 4 were removed. The result is that now paper side polymer layer 5 and machine side polymer layer 5, viewed in the cross machine direction of belt 1, protrude beyond base structure 4 thereby forming groove 9. FIG. 4c illustrates completed belt 1 where groove 9 is completely filled with formless second polymer material 10 which is subsequently solidified to create at least one section of longitudinal edge 3 of belt 1. During the solidification of second polymer material 10, a firm bond was additionally created between second polymer material 10 and base structure 4, as well as between second polymer material 10 and paper side 5 and machine side polymer layer 6. In the current example, the second polymer material was filled into the space by a casting process.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A belt for transporting a fibrous material web in at least one of a web producing machine and a web converting machine from a first transfer location to a second transfer location, the belt bordered in a cross direction on each side by a respective longitudinal edge, the belt comprising:
a weight-carrying base structure;
a polymer layer disposed on said base structure providing a paper side of the belt, said paper side polymer layer protruding in said cross direction beyond said base structure in an area of at least one of said longitudinal edges and including a step extending in a longitudinal direction of the belt; and
a polymer material, said polymer material filling at least sections of said step to define an edge reinforcement in a region of said at least one longitudinal edge, said edge reinforcement providing at least a section of said at least one longitudinal edge of the belt.

2. A belt for transporting a fibrous material web in at least one of a web producing machine and a web converting machine from a first transfer location to a second transfer location, the belt bordered in a cross direction on each side by a respective longitudinal edge, the belt comprising:
a weight-carrying base structure;
two polymer layers including a machine side polymer layer and a paper side polymer layer, wherein said base structure is disposed between said paper side polymer layer and said machine side polymer layer, said two polymer layers protruding beyond said base structure in a region of at least one of said longitudinal edges in said cross direction to define a groove extending in a longitudinal direction of the belt; and
a polymer material, said polymer material filling at least sections of said groove thereby coactively defining an edge reinforcement in a region of said at least one longitudinal edge, said edge reinforcement providing at least a section of said at least one longitudinal edge of the belt.

3. The belt according to claim 2, wherein said polymer material of said edge reinforcement is configured to fill said groove from an end of said base structure.

4. The belt according to claim 3, wherein the belt has a constant thickness over an entire width of the belt.

5. The belt according to claim 2, wherein said polymer material of said edge reinforcement protrudes beyond at least one of said paper side polymer layer and said machine side polymer layer when viewed in said cross direction.

6. The belt according to claim 2, wherein said paper side polymer layer includes a second polymer material and said machine side polymer layer includes a third polymer material, said polymer material of said edge reinforcement being different than at least one of said second polymer material and said third polymer material.

7. The belt according to claim 6, wherein said polymer material of said edge reinforcement has at least one of a greater hardness and a greater abrasion resistance than at least one of said second polymer material and said third polymer material.

8. The belt according to claim 2, wherein said polymer material of said edge reinforcement is thixotropic and has a viscosity in the range of between approximately 400,000 cps and 1,000,000 cps.

9. The belt according to claim 2, wherein said polymer material of said edge reinforcement includes at least one of polyurethane, silicone, polyamide, epoxy resins, polyolefin, polyester and amide.

10. The belt according to claim 2, further comprising a filler having a greater abrasion resistance than said polymeric material of said edge reinforcement, wherein said filler is embedded in said polymer material of said edge reinforcement.

11. The belt according to claim 10, wherein said filler is a particulate filler.

12. The belt according to claim 11, wherein said particulate filler is at least one of silicone carbide and calcium carbonate.

13. The belt according to claim 2, wherein said base structure is at least one of a textile surface structure and a non-textile surface structure.

14. The belt according to claim 13, wherein said textile surface structure is one of a woven structure and a group of yarns extending in at least one of a machine direction and a cross machine direction.

15. The belt according to claim 13, wherein said non-textile surface structure is at least one film.

16. The belt according to claim 2, wherein at least one of said paper side polymer layer and said machine side polymer layer is fluid permeable.

17. The belt according to claim 6, wherein at least one of said second polymer layer and said third polymer material includes polyurethane.

18. A method for manufacture of a belt for one of a web producing machine and a web converting machine, the method comprising the steps of:
a) providing a weight-carrying base structure;
b) coating one side of said base structure with a first polymer material to provide a paper side of the belt;
c) removing part of said base structure in at least one edge area such that said paper side polymer layer protrudes beyond said base structure when viewed in a cross direction of the belt;
d) filling a space between said paper side polymer layer and said base structure with a formless second polymer material to form at least one section of a longitudinal edge of the belt; and
e) solidifying said formless second polymer material.

19. The method according to claim 18, wherein said step b) further comprises the step of at least one of simultaneously and subsequently to said coating of said one side of said base structure with said first polymer material an opposite side of said base structure is coated with a third polymer material.

20. The method according to claim 19, wherein in said step c) said part of said base structure is removed such that said paper side polymer layer and said machine side polymer layer protrude beyond said base structure when viewed in said cross direction of the belt.

21. The method according to claim 20, wherein said step d) further comprises filling a space between said paper side polymer layer, said machine side polymer layer and said base structure with said second polymer material to form at least one section of said longitudinal edge of the belt.

22. The method according to claim 18, wherein in said step d) said second polymer material is filled into said space by a casting process.

23. The method according to claim 18, wherein said base structure includes longitudinal yarns extending in a longitudinal direction of the belt, said step c) further comprising the step of removing two of the outermost yarns of said longitudinal yarns from said base structure in said at least one edge area.

24. The method according to claim 18, wherein said step e) further comprises the step of forming a solid bond between said second polymer material and said base structure and at least one of said paper side layer and said machine side layer.
